(19) United States
(12) Patent Application Publication
(10) Pub. No.: US 2011/0050531 A1
(43) Pub. Date: Mar. 3, 2011

(54) ANTENNA UNIT AND COMMUNICATION DEVICE USING THE SAME

(75) Inventors: Shuichiro YAMAGUCHI, Miyazaki (JP); Kouichi NAKAMURA, Miyazaki (JP)

(73) Assignee: PANASONIC CORPORATION, Osaka (JP)

(21) Appl. No.: 12/869,238

(22) Filed: Aug. 26, 2010

(30) Foreign Application Priority Data
Aug. 28, 2009 (JP) 2009-197843
Mar. 17, 2010 (JP) 2010-060618
Apr. 28, 2010 (JP) 2010-103295

(51) Int. Cl. H01Q 7/04

(52) U.S. Cl. 343/842

(57) ABSTRACT

An antenna unit includes a loop antenna 1; a metallic element 6 provided on one side of an aperture area of the loop antenna 1; and a coil 2 inserted into a line of the loop antenna 1. A coil axis of the coil 2 is parallel to the aperture area of the loop antenna 1 and not parallel to a direction of an electric current flowing through portions of the line of the loop antenna 1 before and after a point where the coil 2 is inserted.

### BACKGROUND

1. Field of the Invention

The present invention relates to an RF-ID; namely, a radio communication medium processing device that establishes communication with a radio communication medium, like an IC card and an IC tag, or an antenna unit used in the radio communication medium itself, as well as to a communication device using the antenna unit.

2. Description of the Related Art

Portable terminals, such as portable phones, equipped with built-in RF-ID radio tags or a function of reading a non-contact IC card or an IC tag have recently become proliferated. An antenna unit that includes a magnetic sheet affixed to an aperture area of a loop antenna (a coil axis of the loop antenna is perpendicular to the magnetic sheet) is frequently used.

However, when a metallic element is in close proximity to a back side of an antenna, communication performance is susceptible to deterioration. However, when a thickness of the magnetic sheet is increased to prevent occurrence of deterioration of communication performance, miniaturization and a reduction in thickness of the portable terminal are hindered.

Accordingly, there has also been contrived an antenna unit using a coil that has a coil axis parallel to a close metallic surface, like an antenna unit (Patent Document 1) focused on a distribution of a magnetic field developing in the vicinity of a metallic element.

Patent Document 1: JP-A-2008-048376

However, the structure (described in connection with Patent Document 1) uses the coil that has the coil axis parallel to the metallic surface. Therefore, in term of communication performance exhibited when the back side of the antenna unit is not close to the metallic element, the contrived antenna unit becomes inferior to the antenna unit using a related art antenna having the magnetic sheet affixed to the aperture area of the loop antenna. Therefore, when a change is made to a location where an antenna is to be mounted for reasons of a design change, or the like, there arises a problem of use of an intended antenna being precluded. Development may be hindered by a necessity to select another antenna from the beginning, or the like.

Accordingly, in view of the drawback, the present invention aims at providing an antenna unit that exhibits superior communication performance without regard to a distance between an antenna and a metallic element, as well as providing a communication device using the antenna unit.

### SUMMARY

In order to solve the problem, the present invention provides an antenna unit comprising: a loop antenna; and a coil inserted into a line of the loop antenna, wherein a coil axis of the coil is parallel to an aperture area of the loop antenna and not parallel to a direction of an electric current flowing through portions of the line of the loop antenna before and after a point where the coil is inserted.

The present invention makes it possible to provide an antenna unit that exhibits superior communication performance without regard to a distance between an antenna and a metallic element.

### BRIEF DESCRIPTION OF THE DRAWINGS

FIG. 1 is a conceptual rendering of an antenna unit of an embodiment of the present invention;

FIG. 2 is a conceptual rendering of the antenna unit of the embodiment of the present invention;

FIG. 3 is a conceptual rendering of the antenna unit of the embodiment of the present invention;

FIG. 4 is a conceptual rendering of the embodiment of the present invention achieved when a metallic element is located at a distant position and when an antenna performs transmission;

FIG. 5 is a conceptual rendering of the embodiment of the present invention achieved when the metallic element is located at the distant position and when the antenna receives a magnetic field from the outside;

FIG. 6 is a conceptual rendering of the embodiment of the present invention achieved when the metallic element is located at a close position and when the antenna performs transmission;

FIG. 7 is a conceptual rendering of the embodiment of the present invention achieved when the metallic element is located at the close position and when the antenna receives the magnetic field from the outside;

FIG. 8 is a conceptual rendering of a related art example antenna unit achieved when the metallic element is located at the close position and when the antenna performs transmission;

FIG. 9 is a conceptual rendering of the related art example achieved when the metallic element is located at the close position and when the antenna receives the magnetic field from the outside;

FIG. 10 is a view of the related art antenna unit when the metallic element is closely placed;

FIG. 11 is a conceptual rendering of the embodiment of the present invention;

FIG. 12 is an oblique perspective view of a portable terminal acquired when the portable terminal is disassembled;

FIG. 13 is a conceptual rendering of a related art example antenna unit;

FIG. 14 is a graph showing results of tests pertaining to distances to a substrate and magnetic field intensity;

FIG. 15 is a graph showing results of tests pertaining to angles and magnetic field intensity;

FIG. 16 is a conceptual rendering of an antenna unit of the present invention used in the test;

FIG. 17 is a conceptual rendering of the related art example used in the test;

FIG. 18 is a conceptual illustration of communication between terminals;

FIG. 19 is a graph showing results of a winding number test;

FIG. 20 is a conceptual rendering of the embodiment of the present invention;

FIG. 21 is a conceptual rendering of the antenna unit of the embodiment of the present invention;

FIG. 22 is a conceptual rendering of the embodiment of the present invention achieved when the metallic element is located at the distant position and when the antenna performs transmission;

FIG. 23 is a conceptual rendering of the embodiment of the present invention achieved when the metallic element is located at the distant position and when the antenna receives a magnetic field from the outside;

FIG. 24 is a conceptual rendering of the embodiment of the present invention achieved when the metallic element is located at the close position and when the antenna performs transmission;

FIG. 25 is a conceptual rendering of the embodiment of the present invention achieved when the metallic element is located at the close position and when the antenna receives the magnetic field from the outside;

FIG. 26 is a conceptual rendering of the antenna unit of the embodiment of the present invention; and

FIG. 27 is a conceptual rendering of the antenna unit of the embodiment of the present invention.

### DETAILED DESCRIPTION

According to the present invention, an antenna unit is configured by including a loop antenna and a coil inserted into a line of the loop antenna. A coil axis of the coil is parallel to an aperture area of the loop antenna and not parallel to a direction of an electric current flowing through portions of the line of the loop antenna before and after a point where the coil is inserted. Thus, it is possible to provide an antenna unit exhibiting superior communication performance without regard to a distance between the antenna and the metallic element.

The coil is provided in numbers in the loop antenna. An eddy current induced in the metallic element by the plurality of coils can thereby be efficiently utilized. Therefore, it is possible to provide an antenna unit that exhibits superior communication performance even when the metallic element is placed closely.

Turns of a conductor making up the coil are made larger or smaller than an integral multiple by about one-half of turn. Terminals of the coil can thereby be provided at both ends of the coil, so that the coil can easily be inserted into a line making up the loop antenna.

The conductor wound around a side of the coil facing the metallic element is smaller in number than the conductor wound around a side of the coil opposite to its side facing the metallic element. The coil thereby can efficiently generate a magnetic field and also efficiently capture the magnetic field.

The coil is inserted into mutually-opposing two sides of the loop antenna. A balance of a communication distance between; for instance, horizontally arranged terminals, can readily be accomplished.

When the loop antenna is placed in close proximity to a metallic element, the coil is situated at an end of the metallic element. It is thereby possible to utilize a portion of the metallic element where a high density of eddy current appears, so that an antenna unit exhibiting high communication performance can be provided.

According to the present invention, an antenna unit is configured by including an oblong or square loop antenna and at least two coils that are placed in the line of the loop antenna and inserted into respective mutually-opposing sides of the antenna. The coil axes of the coils are parallel to an aperture area of the loop antenna. Further, the coil axes are not parallel to a direction of an electric current flowing through portions of the line of the loop antenna located before and after the points where the coils are inserted. As a result of adoption of such a configuration, it is possible to provide an antenna unit that exhibits superior communication performance without regard to a distance between the antenna and the metallic element.

Further, since the two coils are equal in length to each other in their longitudinal directions, it becomes possible to lessen a deviation in communication performance of the antenna unit.

Moreover, an entirety of one side of the loop antenna corresponds to a coil. A large aperture can thereby be given to the coil, whereby performance of the antenna unit can be enhanced.

Roll centers of the two coils are arranged so as to become offset from each other. Magnetic fields developing in the two coils in different directions are thereby prevented from interfering with each other, which in turn contributes to an improvement in a degree of design freedom.

According to the present invention, an antenna unit is configured by including an oblong or square loop antenna and at least one coil that is placed in the line of the loop antenna and inserted into a position on the line of the loop antenna where the terminals oppose each other. The coil axis of the coil is parallel to an aperture area of the loop antenna. Further, the coil axis is not parallel to a direction of an electric current flowing through portions of the line of the loop antenna located before and after the point where the coil is inserted. By adoption of such a configuration, it is possible to provide an antenna unit that exhibits superior communication performance without regard to a distance between the antenna and the metallic element.

According to the present invention, a communication device is configured by including an antenna unit including a loop antenna and a coil inserted into a line of the loop antenna; and a metallic element by way of which the loop antenna is placed in close proximity to a substrate, wherein a coil axis of the coil is parallel to an aperture area of the loop antenna and not parallel to a direction of an electric current flowing through portions of the line of the loop antenna before and after a point where the coil is inserted. As a result of adoption of such a configuration, it is possible to provide a communication device that exhibits superior communication performance without regard to a distance between the antenna and the metallic element.

Further, there is provided the communication device defined in claim 12, wherein the coil is situated at an end of the metallic element. Since a portion of the metallic element where a high density of eddy current appears can be utilized, there can be provided a communication device exhibiting superior communication performance.

According to the present invention, a communication device is configured by including an antenna unit including a loop antenna and a coil inserted into a line of the loop antenna; a substrate connected to the antenna unit; and an enclosure enclosing the antenna unit and the substrate, wherein a coil axis of the coil is parallel to an aperture area of the loop antenna and not parallel to a direction of an electric current flowing through portions of the line of the loop antenna before and after a point where the coil is inserted. As a result of adoption of such a configuration, it is possible to provide a communication device that exhibits superior communication performance without regard to a distance between the antenna and the metallic element.

There is configured the antenna unit defined in claim 14 and characterized in that the substrate is a metallic element; that the loop antenna is placed in close proximity to the substrate; and that the coil is situated at an end of the substrate. Since the portion of the substrate where a high density of eddy current appears can be utilized, there can be provided a communication device exhibiting superior communication performance.

There is provided an antenna unit defined in claim 14 characterized in that the enclosure is a metallic element; that the loop antenna is placed in close proximity to the enclosure; and that the coil is situated at an end of the enclosure. Since a portion of the enclosure where a high density of eddy current appears can be utilized, there can be provided a communication device exhibiting superior communication performance.

### Embodiment

An embodiment of the present invention is hereunder described by reference to the drawings.

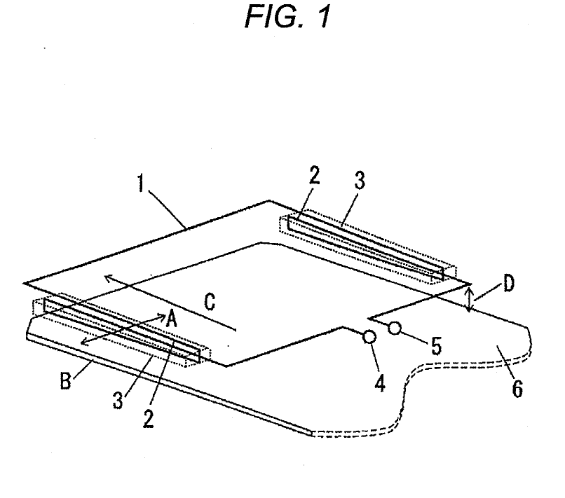

FIG. 1 is a conceptual rendering of an antenna unit of the embodiment of the present invention.

A loop antenna 1 is assumed to provide a path from an antenna input/output terminal 4 (or 5) to a remaining antenna input/output terminal 5 (or 4) along which an electric current flows and is defined as transmitting and receiving a signal by means of a magnetic field induced by an electric current or an electric current induced by an external magnetic field. Further, an area surrounded by a line of the loop antenna 1 is defined as an aperture area of the loop antenna 1.

Specifically, in the embodiment, the loop antenna 1 is controlled so as to be able to transmit and receive a radio wave for; e.g., RFID (13.56 MHz).

In the embodiment, a coil 2 is inserted into two arbitrary points in a line making up the loop antenna 1 along with cores 3 wound around the respective coils 2. When a coil axis of one coil 2 is taken as A, the coils 2 are arranged such that the coil axis A is parallel to the aperture area of the loop antenna 1 and perpendicular to a direction of an electric current that flows through portions of the line of the loop antenna 1 before and after the point where the coil is inserted (i.e., a direction C in FIG. 1 of the embodiment).

In the embodiment, the coil axis A is perpendicular to the direction C but must be parallel to the same.

Moreover, in the embodiment, the coils 2 are arranged so as to become perpendicular to an end face B of a metallic element 6 spaced from the coil by a distance D. A conceivable distance D ranges from 0 mm to ∞. As will be described later, the coil exhibits superior communication performance for the antenna unit at any distance.

Using a magnetic element for the cores 3 is preferable, because the number of magnetic fluxes passing through the coils 2 can be increased, and communication performance exhibited when a metallic element is close to the antenna is enhanced. However, the material of the core is not limited to the magnetic element but can also be made of ceramic, a resin, or the like.

FIG. 1 illustrates a case where the coil 2 is provided at two locations; however, the number of locations is not limited to two. Further, the coils 2 are inserted into two respective mutually-opposing sides in FIG. 1. Since a balanced communication distance is attained in a horizontal direction of; for instance, a terminal by means of such an arrangement, such an arrangement is preferable.

Moreover, the coils 2 provided at two locations in FIG. 1 assume the same shape but may also differ from each other in terms of a shape, a winding number, and others. However, since a chance of occurrence of erroneous mounting of coils, which would otherwise arise during mass production, and the number of component types, can be decreased, giving the same shape to the coils 2 is preferable.

Further, the number of conductor turns of the individual coil 2 is illustrated as about 1.5 turns in the present embodiment. Further, the number of conductor turns wound around a side of the individual core 3 facing the metallic element (the number of conductor turns wound around the side of the core 3 facing the metallic element when the conductor is wound around the core 3) is made smaller than the number of conductor turns wound around a side of the individual core 3 opposite to its side facing the metallic element.

By means of adoption of such a structure, it is possible to realize an antenna unit that exhibits superior efficiency by a smaller number of conductor turns.

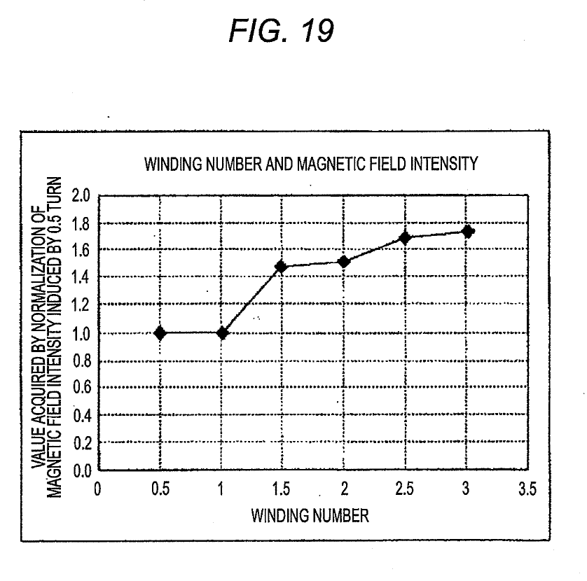

FIG. 19 shows results of a winding number test. Winding numbers are plotted along a horizontal axis, and values acquired by normalization of magnetic field intensity induced by a 0.5 turn are plotted along a vertical axis. In the coils 2 used in the test, ferrite measuring 21 mm×4 mm×0.2 mm was used for the core 3. The coils were experimentally manufactured from a thin copper plate having a thickness of 0.1 mm while the width of the copper plate was changed from 1 mm to 0.6 mm in accordance with the number of turns. The coil 2 was placed in close proximity to the end of the metallic element; 50Ω matching was provided at 13.56 MHz; and a sinusoidal wave signal that exhibited a sensitivity of 20 dBm at 13.56 MHz was input from the signal generator to the antenna, and magnetic field intensity was measured at a point elevated 30 mm from the principal plane of the metallic element.

As shown in FIG. 19, the magnetic field intensity increases with an increase in winding number. However, an increase rate shows that the magnetic field intensity greatly increases when the winding number is larger than an integral number by one-half of turn. The conductor situated on a side where the conductor does not face the metallic element 6 is less susceptible to the eddy current flowing over the surface of the metallic element 6. However, an electric current develops, in a direction of being cancelled by the eddy current flowing over the surface of the metallic element 6, in the conductor of the coil 2 situated on a side where the conductor faces the metallic element 6. Therefore, an increase in magnetic field intensity can be presumed to be small when the winding number assumes an integral number.

The test shown in FIG. 19 was conducted while the loop antenna 1 was not provided. However, even when the loop antenna 1 is formed, the coils 2 are considered to undergo similar influence from the metallic element 6. Therefore, an efficient antenna unit requiring a smaller number of turns can be said to be formed from the coils 2 inserted into the loop antenna 1.

A limitation is not imposed on the number of turns. The number of turns may be larger or smaller than about 1.5 turns shown FIG. 1.

As a result of the number of conductor turns being increased or decreased as compared with an integral multiple by about one-half of turn, both ends of the coil 2 (portions of the coil connected to the loop antenna 1) are formed on both sides with the core 3 sandwiched therebetween. Therefore, insertion of the coil into the loop antenna 1 becomes easier.

Specifically, since the coil can be inserted in such a way that a linear portion of an ordinary loop antenna is replaced with the coil, insertion of the coil becomes easier.

Further, a way to wind the coils 2 may be clockwise or counterclockwise. According to a position where the antenna is to be placed, the way to wind the coils can be selected, as required.

A commonly utilized method, such as a soldered connection and a connector connection, can be used for making a connection between the coils 2 and the conductor of the loop antenna 1. Alternatively, the coils 2 and the loop antenna 1 can also be formed from a single continuous conductor. As is commonly known, the antenna input/output terminals 4 and 5 are to be connected to input/output terminals of a matching circuit and an IC. A commonly utilized method, such as a pin contact, a spring contact, pin soldering, spring soldering, and a connector connection, can be utilized, as a connection method.

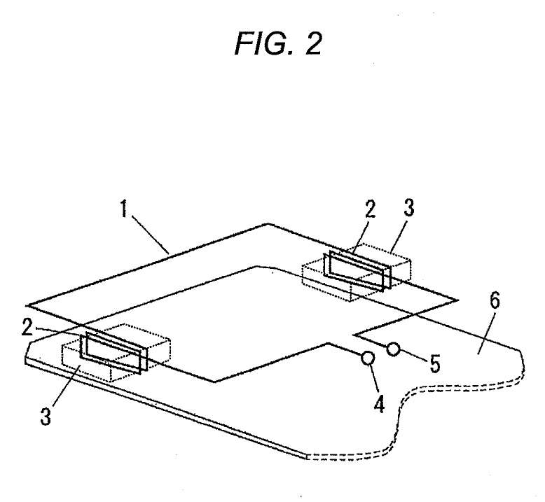

FIG. 2 is a conceptual rendering of the antenna unit of the embodiment of the present invention. In the embodiment, the coil axes of the coils 2 are arranged so as to become parallel to short sides of the respective cores 3. However, in FIG. 2, the coil axes of the coils 2 are made parallel to the long sides of the respective individual cores 3, and the coils 2 and the cores 3 differ from each other in terms of a shape. Specifically, as shown in FIG. 2, the shape of the coils 2 and the shape of the cores 3 can freely be selected according to a desired characteristic and a space where the antenna is to be mounted.

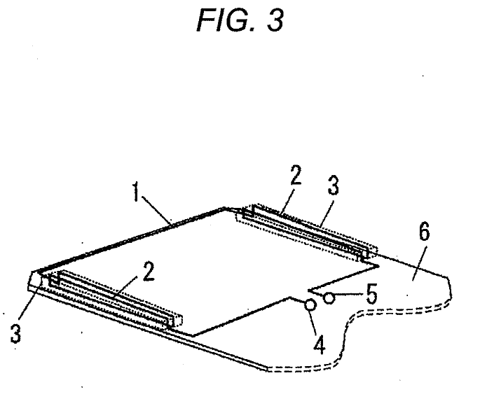

FIG. 3 is a conceptual rendering of the antenna unit of the embodiment of the present invention.

The antenna unit is built from the loop antenna 1, the coils 2, the cores 3, and antenna input/output terminals 4 and 5 that are provided in close proximity to the metallic element 6. The coils 2 are arranged so as to come to respective ends of the metallic element 6. When a magnetic field perpendicular to the aperture area of the loop antenna 1 comes from the outside, an eddy current develops in a surface of the metallic element 6. The eddy current exhibits a higher density closer to the ends of the metallic element 6. Since the eddy current flowing over the surface of the metallic element 6 can most efficiently be utilized, it is preferable to place the coils 2 so as to be situated at the respective ends of the metallic element 6. Further, since a density of the eddy current becomes lower at corners of the metallic element 6, avoiding placement of the coils 2 at the corners is desirable.

FIG. 3 is presumably intended for a portable terminal in which difficulty is encountered in assuring spacing between the antenna unit and the metallic element 6. In this case, the metallic element 6 becomes equivalent to; for instance, a substrate in the portable terminal. However, the metallic element can also be equivalent to another metallic element; for instance, a battery, a liquid crystal display panel, or the like. Moreover, the conductor making up the loop antenna 1 can also be formed from a sheathed copper line, or the like. However, the conductor can also be an electrode pattern, or the like, laid on the metallic element 6. In addition, the coils 2 and the magnetic cores 3 can also be arranged so as to be mounted on the metallic element 6. Although un-illustrated, the another component; for instance, a camera module, a speaker, an RF module, an antenna for another frequency, and others, can be mounted in interior spacing of the loop antenna 1.

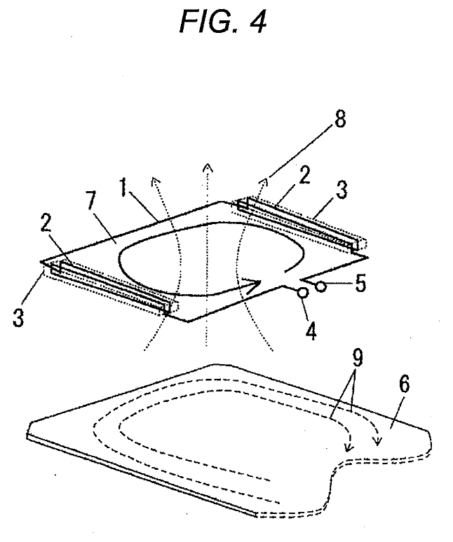

Operating concepts of the antenna unit of the present invention are now described by reference to FIGS. 4 through 8.

FIG. 4 is a conceptual rendering of the present invention achieved when the metallic element is located at a distant position and when an antenna performs transmission. By means of a signal input to the antenna input/output terminals 4 and 5, an electric current 7 flows into the loop antenna 1, whereupon a magnetic field 8 develops. A magnetic field 13 induced by the coils 2 is perpendicular to the magnetic field 8 and hence does not exert any influence on the magnetic field 8. Although an eddy current 9 develops in the metallic element 6 in a direction of canceling the magnetic field 8 induced by the electric current 7, the eddy current does not exert much influence on the magnetic field 8, because the metallic element 6 is situated at the distant position. Therefore, when the metallic element 6 is located at the distant position, the antenna unit effects communication in the same manner as does the related art loop antenna. For this reason, even when the metallic element is located at the distant position, a superior communication state can be acquired.

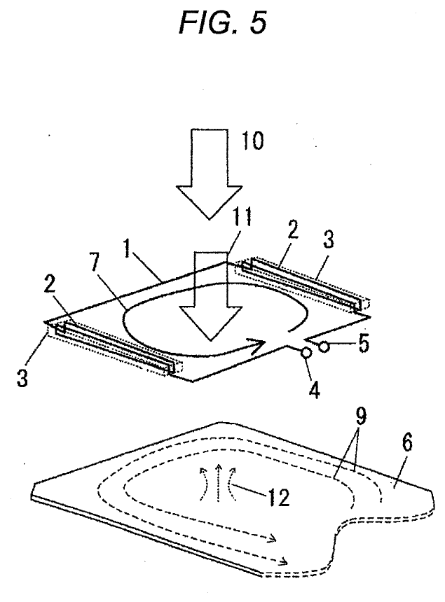

FIG. 5 is a conceptual rendering of the present invention achieved when the metallic element is located at the distant position and when the antenna receives a magnetic field from the outside. An external magnetic field 10 and a magnetic field 11 passing through the loop antenna 1 are related to a distance. The electric current 7 is induced in the loop antenna 1 by the magnetic field 11 and goes out of the antenna from the antenna input/output terminals 4 and 5. Since the coil axes of the coils 2 are perpendicular to the magnetic field 11, the coil axes do not exert influence on the electric current 7. Although the eddy current 9 is induced in the metallic element 6 by the magnetic field 10, to thus resultantly induce a magnetic field 12 in opposite direction, the magnetic field exerts little influence on the electric current, because the metallic element 6 is placed at the distant position. Therefore, when the metallic element 6 is placed at the distant position, the antenna unit effects communication in the same manner as does the related art loop antenna, the antenna unit of the present invention can provide a superior communication state even when the metallic element is located at the distant position.

Specifically, in the present embodiment, the coils 2 are arranged such that an electric current arises in a direction of canceling the eddy current 9.

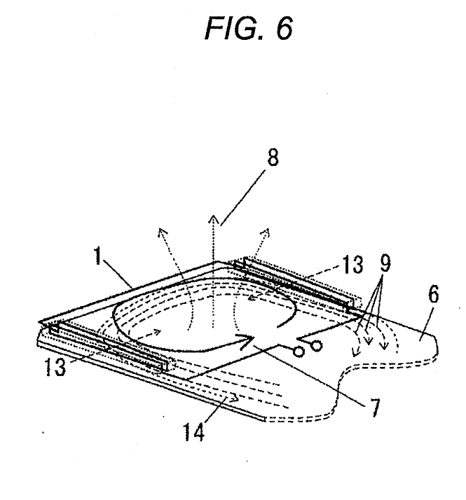

FIG. 6 is a conceptual rendering of the present invention achieved when the metallic element is located at a close position and when the antenna performs transmission. The signal entered the antenna input/output terminals 4 and 5 induces the electric current 7 in the loop antenna 1, whereupon the magnetic field 8 develops. The eddy current 9 develops in the metallic element 6 in a direction of canceling the magnetic field 8 induced by the electric current 7. The magnetic field 8 is supposed to consequently become smaller, thereby deteriorating the communication performance of the antenna. However, the magnetic field 13 passing through the coils 2 is induced by the electric current flowing through the coils 2, and an electric current 14 is induced in the metallic element 6 by the magnetic field 13. Since the electric current 14 is opposite in direction to the eddy current 9 and since they cancels each other, the magnetic field 8 eventually undergoes little influence from the eddy current 9. Therefore, even when the metallic element 6 is placed at the close position, the antenna unit of the present invention can provide a superior communication state.

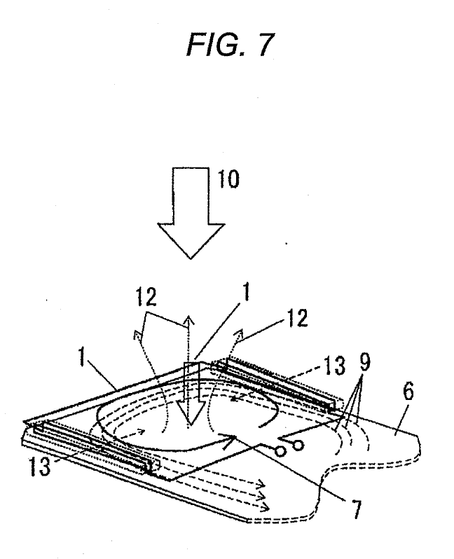

FIG. 7 is a conceptual rendering of the present invention achieved when the metallic element is placed at the close position and when the antenna receives a magnetic field from the outside. The external magnetic field 10 induces the electric current 7 in the loop antenna 1, as well as inducing the eddy current 9 in the metallic element 6. Since the metallic element 6 and the loop antenna 1 are located adjacently, the magnetic field 11 passing through the loop antenna 1 is supposed to be reduced by the magnetic field 12 induced in the opposite direction by the eddy current 9, with the result that the electric current 7 will become smaller. However, the magnetic field induced by the eddy current 9 passes through the coils 2, whereby an electric current generating the magnetic field 13 flows into the coils 2. The electric current 7 consequently does not become smaller in quantity. Therefore, even when the metallic element 6 is placed at the close position, the antenna unit of the present invention can provide a superior communication state.

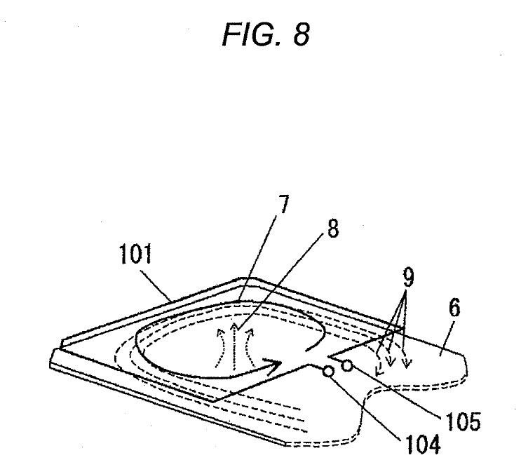

FIG. 8 is a conceptual rendering of an example related art antenna unit, as a comparative example, achieved when the metallic element is placed at the close position and when the antenna performs transmission. When the antenna is spaced apart from the metallic element, the antenna certainly undergoes no influence of the metallic element. However, as shown in FIG. 8, the signal entered the antenna input/output terminals 4 and 5 let the electric current 7 flow into a loop antenna 101, thereby generating a magnetic field 8. The eddy current 9 develops in the metallic element 6 in a direction of canceling the magnetic field 8 induced by the electric current 7, and the magnetic field 8 eventually becomes smaller, to thus deteriorate communication performance of the antenna. Therefore, when the metallic element 6 is placed at the close position, the related art loop antenna 101 fails to exhibit sufficient communication performance.

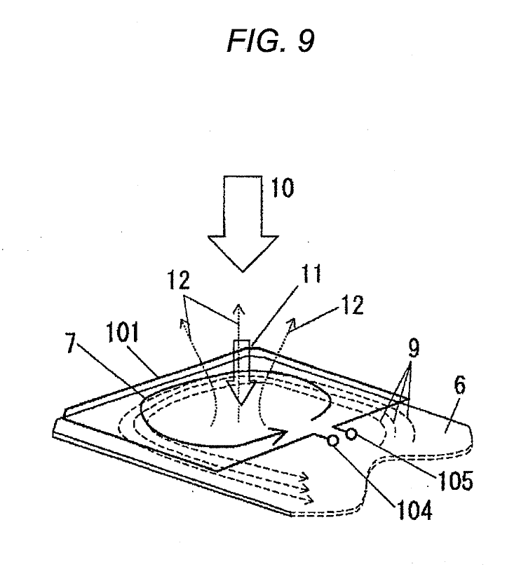

FIG. 9 is a conceptual rendering of the related art example achieved when the metallic element is placed at the close position and when the antenna receives a magnetic field from the outside. The external magnetic field 10 induces the electric current 7 in the loop antenna 101, as well as inducing the eddy current 9 in the metallic element 6. Since the metallic element 6 and the loop antenna 101 are located adjacently, the magnetic field 11 passing through the loop antenna 101 is supposed to be reduced by the magnetic field 12 induced in the opposite direction by the eddy current 9, with the result that the electric current 7 will become smaller. Therefore, when the metallic element 6 is placed at the close position, the related art loop antenna 101 fails to exhibit sufficient communication performance.

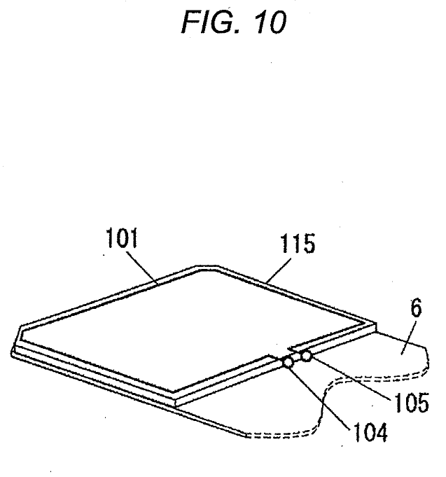

Under the circumstances shown in FIGS. 8 and 9, a magnetic sheet 115 is commonly utilized to lessen the influence of the metallic element 6 as shown in FIG. 10. However, this results in an increase in footprint and thickness of the antenna, thereby posing difficulty in miniaturization of the portable phone equipped with the antenna.

In the states in FIGS. 6 and 7 corresponding to the embodiment, the metallic element 6 can also be said to be utilized as an antenna by utilization of the electric current flowing through the metallic element 6. Since the metallic element of the portable terminal is larger than the antenna unit, the ability of a small-footprint antenna to utilize a large metallic element as an antenna unit is considered to be able to greatly contribute to a reduction in size and thickness of a portable terminal in future.

Although the loop antennas 1 and 101 are illustrated by one turn in the aforementioned drawings, the number of turns is not limited to one but may be plural. When a number of turns are employed, it is preferable to form only a portion of the outermost periphery path of the loop antenna 1 from the coils 2 or to insert cores into paths of the respective turns such that the coil axes of the respective coils 2 become common, because deterioration of communication performance that will arise when the metallic element comes close to the antenna unit is lessened. Although the antenna is illustrated by means of one line, this is intended for the brevity of the drawings. In reality, the antenna has a width and thickness.

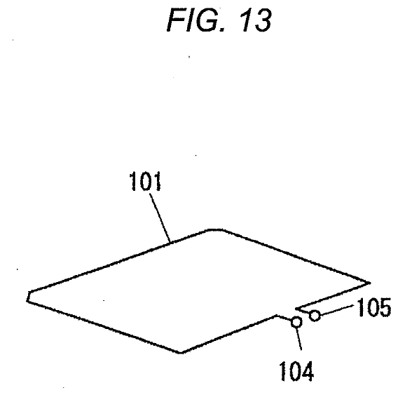

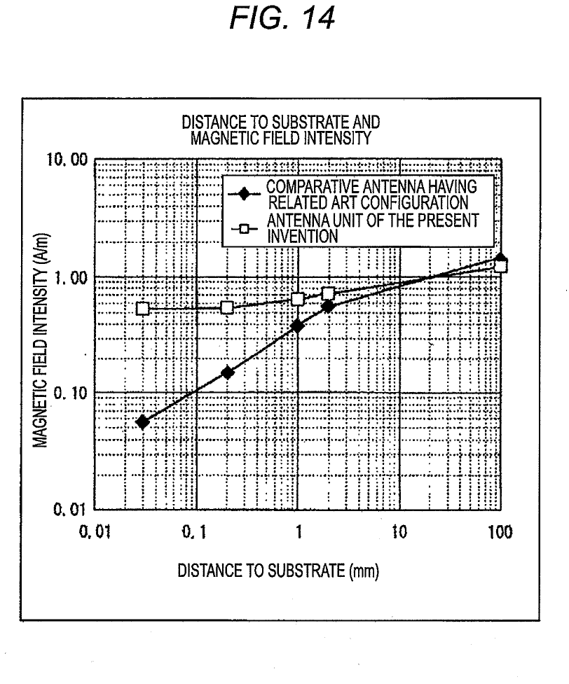

FIG. 14 shows results acquired as a result of testing of the antenna unit of the present invention and comparative antennas formed from a related art structure, such as those shown in FIG. 13. A horizontal axis represents a distance between a metallic element and an antenna. A vertical axis represents a plot of magnetic field intensity measured at a position elevated from the antenna by 30 mm when the antenna provided 50Ω matching at 13.56 MHz and when a sinusoidal wave signal of 20 dBm was input at 13.56 MHz.

The antenna unit of the present invention employed in the test was experimentally manufactured by means of a structure, such as that described in connection with the embodiment shown in FIG. 1. Namely, an outer shape of the loop is set so as to measure 40 mm×25 mm. Each of the two 25 mm sides is replaced with one coil including a magnetic core that measures 21 mm×4 mm×0.2 mm and around which a thin copper plate having a line width of 1 mm and a thickness of 0.1 mm is wound 1.5 turns. On the contrary, the antenna of related art structure for comparison purpose was experimentally manufactured by means of a structure, such as that shown in FIG. 13. Namely, an outer shape of the loop is likewise set so as to measure 40 mm×25 mm and formed by one turn of a thin copper plate having a line width of 1 mm and a thickness of 0.1 mm. A solid substrate presumably intended for a portable terminal measuring 40 mm×110 mm was used for the metallic element.

As is seen from FIG. 14, when compared with a case where the related art antenna unit stays away from the metallic element, the antenna unit cannot maintain the communication characteristic when the metallic element is approaching the antenna unit, because the magnetic field intensity falls to a factor of one-tenth or less. On the contrary, in the antenna unit of the present invention, deterioration of the magnetic field intensity is small even when the metallic element approaches the antenna unit. Even when the metallic element is located near the antenna unit, the antenna unit can maintain the communication characteristic. Consequently, the present invention can be said to be able to provide an antenna unit exhibiting superior communication performance regardless f a distance between the antenna and the metallic element.

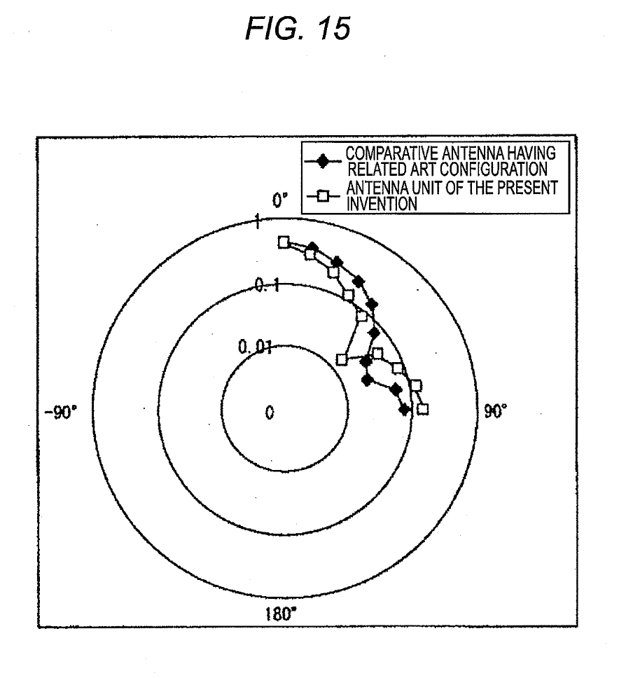

A communication range of the present invention is now described by reference to FIGS. 15 to 18.

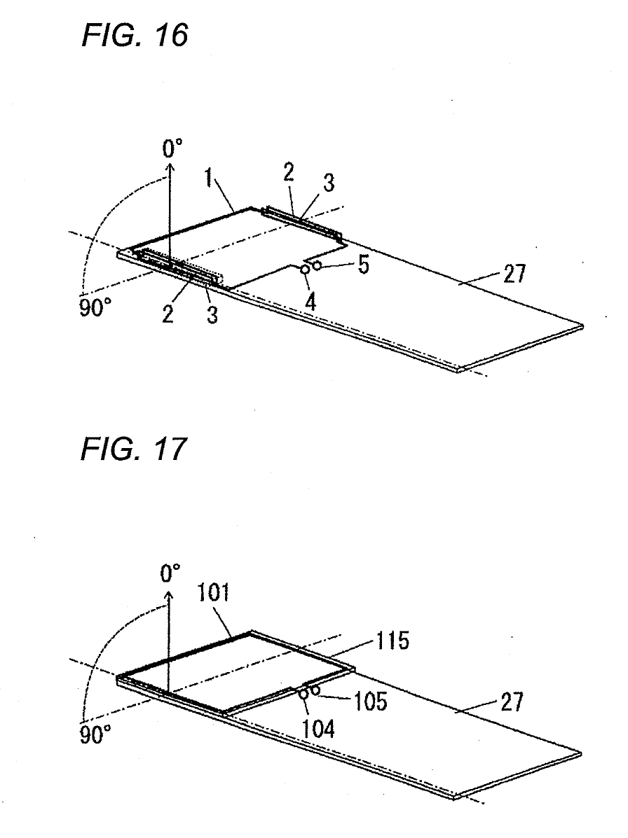

FIG. 15 shows a result acquired when the antennas used in the test shown in FIG. 14 were arranged as illustrated in FIG. 16 and FIG. 17 and when the magnetic field intensity acquired at a distance of 30 mm away from a side surface of the antenna was measured from 0° to 90°. A solid substrate that imitates a portable terminal and that measures 40 mm×110 mm was used for a substrate 27. During measurement of the comparative antenna of the related art configuration, a magnetic sheet measuring 41 mm×26 mm×0.2 mm was inserted between the loop antenna 101 and the substrate 27, as shown in FIG. 17, such that the magnetic field intensity achieved in a direction of 0° became identical with that shown in FIG. 16.

As is seen from FIG. 15, the antenna unit of the present invention is superior to the comparative antenna having the related art configuration in terms of magnetic field intensity acquired in a direction of 90°. The reason for this is that a magnetic field acquired in a direction of 90° is intensified because the coil axis is parallel to the substrate.

In short, in the related art antenna, the coil axis of the loop antenna is perpendicular to the substrate. Therefore, when the coil axis is perpendicular to the substrate (i.e., in a direction of 0°), the communication characteristic can be maintained. However, when the coil axis is oriented in a direction of 90°, the coil axis of the loop antenna becomes perpendicular to the direction of the magnetic field; hence, the communication characteristics of the antenna become deteriorated. However, in the present embodiment, when the coil axis is oriented in a direction of 90°, the direction of the coil axis of the coil and the direction of the magnetic field coincide with each other. Therefore, the communication characteristic can be maintained.

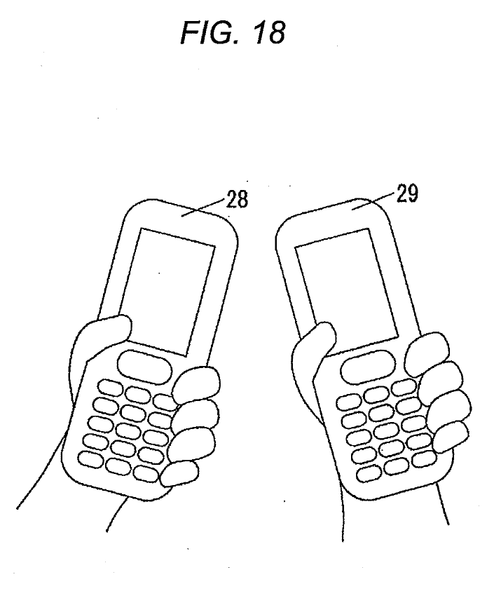

As shown in FIG. 18, this is advantageous for inter-terminal communication (peer-to-peer communication) by means of which data are exchanged between terminals 28 and 29 while the terminals are viewed side by side on a screen. Further, the antenna unit is also compatible with a communication directed toward a back side of a terminal (in a direction of 0° shown in FIG. 15), such as that primarily performed at payment or ticket examination in the related art. Therefore, the present invention can be said to be very effective.

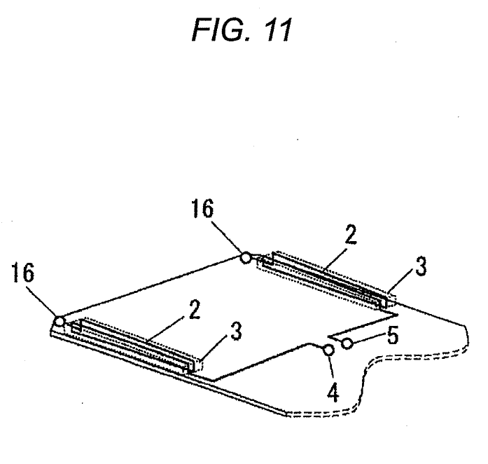

In the present embodiment, the loop antenna is utilized. However, as shown in FIG. 11, there may also be employed a shape in which terminals 16 of the coils 2 mounted on the metallic element 6 are connected to a ground of the metallic element 6.

In this case, when a consideration is given to a case where the terminals 16 are connected together by means of sheathed copper lines held in close contact with the metallic element 6, closely-contacted portions of the copper lines do not induce an electric current. Therefore, the terminals 16 are understood to be equal to each other in terms of an electric potential.

Therefore, the terminals 16 can be connected to the metallic element 6, whereby there is formed a loop path running from the antenna input/output terminal 4 to the input/output terminal 5 by way of the coil 2, the terminal 16, the metallic element 6, the other terminal 16, and the other coil 2. The arrangement makes it possible to omit a portion of the conductor of the loop antenna 1, so that a terminal design can be simplified.

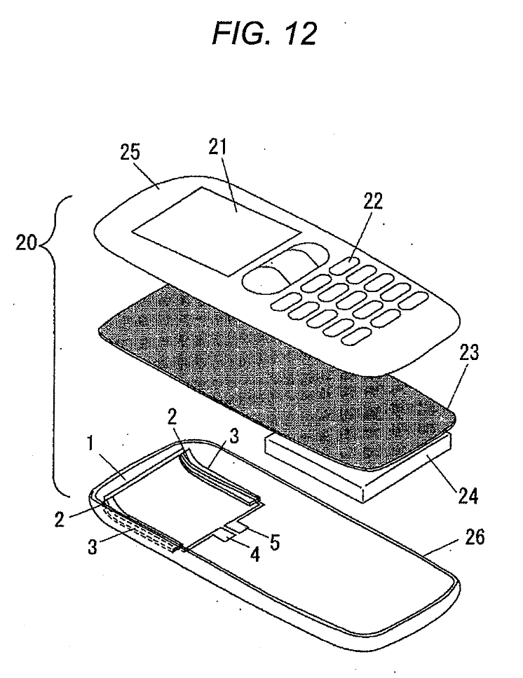

Next, detailed explanations are given to a case where the antenna unit of the present invention is mounted on the portable terminal. FIG. 12 is an oblique perspective view acquired when the portable terminal of the embodiment of the present invention is disassembled.

A portable terminal 20 includes a liquid crystal panel 21, operation buttons 22, an enclosure 25, an enclosure 26, and a substrate 23 and a battery 24 enclosed in the enclosures, and others. The loop antenna 1, the coils 2, the core 3, and the antenna input/output terminals 4 and 5, all belonging to the present invention, are formed on an interior of the enclosure 26. A line of the loop antenna 1 and the antenna input/output terminals 4 and 5 are formed from a steel plate, a metallic foil tape, or printing. The coils 2 are mounted to predetermined locations by means of affixation effected by means of an adhesive tape, fixation effected by means of screws, or the like. Connection of the line of the loop antenna 1 to the coils 2 is performed by means of contact connection effected by use of connectors or crimping, soldering, welding, or the like. A conceivable way to connect the antenna input/output terminals 4 and 5 to an IC is contacting effected by pins, connection effected by connectors, soldering of a conductor line, and the like. Components, such as an RF-ID IC, a matching circuit, an antenna for another frequency, a camera unit, a speaker, and an RF module are arranged in a space existing between the enclosure 26 and the substrate 23. Superior communication can be performed even when these components are located in proximity to or spaced apart from the loop antenna 1, the coils 2, and the core 3.

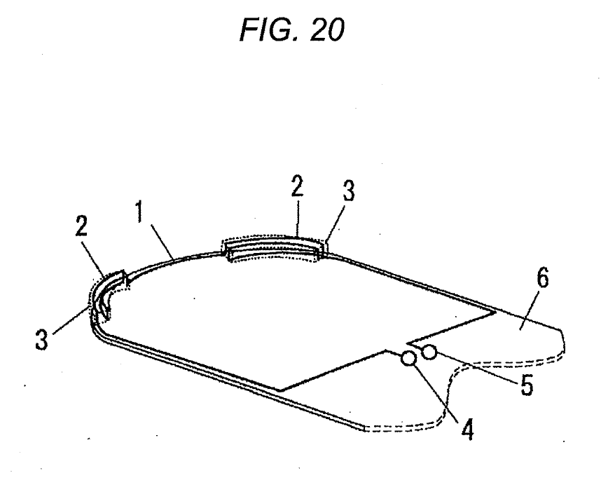

Moreover, end faces of the metallic element 6 are formed as planar surfaces in FIGS. 1 through 3. The coils 2 are also formed from a straight conductor. However, the end faces of the metallic element 6 can be curved surfaces as illustrated in FIG. 20, and the coils 2 can also be formed from curved lines in conformance with the curved surfaces of the end faces of the metallic element 6.

The antenna unit of the present embodiment can also be implemented as an antenna unit having the following characteristics. In particular, the antenna unit has the loop antenna 1 assuming an oblong or square shape and at least two coils 2 that are placed in the line of the loop antenna 1 and inserted into respective mutually-opposing sides of the antenna. The coil axes of the coils 2 are parallel to the aperture area of the loop antenna 1. Further, the coil axes are not parallel to a direction of an electric current flowing through portions of the line of the loop antenna 1 located before and after the points where the coils 2 are inserted. By adoption of such a configuration, it is possible to provide an antenna unit that exhibits superior communication performance without regard to a distance between the antenna 1 and the metallic element 6. Further, since the two coils 2 are equal in length to each other in their longitudinal directions, it becomes possible to lessen a deviation in communication performance of the antenna unit.

Further, the number of conductor turns making up each of the coils 2 is made larger or smaller than an integral multiple by about one-half of turn, whereby the terminals of the coils 2 can be provided at both ends of the respective coils 2. Hence, the line making up the loop antenna 1 can readily be inserted.

Moreover, the metallic element 6 is placed on one side of the aperture area of the loop antenna 1, and the conductor turns wound around the side of the coil 2 facing the metallic element 6 are made smaller in number than the conductor turns wound around the side of the coil 2 opposite to its side facing the metallic element 6. The coils can efficiently generate a magnetic field, and the magnetic field can efficiently be captured.

The entirety of each of the sides of the loop antenna 1 is made up of the coil 2, whereby an opening between the coils 2 can be made large, so that the performance of the antenna unit can be enhanced.

When the loop antenna 1 is placed in close proximity to the metallic element 6, the coils 2 are located along the respective ends of the metallic element 6. Portions of the metallic element 6 where a high density of an eddy current appears can be utilized. Therefore, an antenna unit exhibiting superior communication performance can be provided.

Roll centers of the two coils 2 are arranged so as to become offset from each other. Magnetic fields developing in the two coils 2 in different directions are thereby prevented from interfering with each other, which in turn contributes to an improvement in a degree of design freedom.

The antenna unit of the present invention also has the oblong or square loop antenna 1 and at least one coil 2 inserted into a point on the line of the loop antenna 1 where terminals oppose each other. The antenna unit can also be implemented as an antenna unit including the coils 2 in which the coil axes of the coils 2 are parallel to the aperture area of the loop antenna 1 and in which the coil axes of the coils 2 are not parallel to the direction of the electric current flowing potions of the line of the loop antenna 1 before and after points where the coils 2 are inserted. It is thereby possible to provide an antenna unit that exhibits superior communication performance without regard to a distance between the antenna and the metallic element.

The metallic element is provided on one side of the aperture area of the loop antenna 1, and the number of conductor turns wound around the side of the coil 2 facing the metallic element 6 is made smaller than the number of conductor turns wound around the side of the coil 2 opposite to its side facing the metallic element 6. The coils can thereby generate a magnetic field efficiently, and the magnetic field can also be captured efficiently.

Further, an entirety of each of the sides of the loop antenna 1 is made up of the coil 2, so that an opening formed between the coils 2 can be made large, and performance of the antenna unit can be enhanced.

When the loop antenna 1 is placed in proximity to the metallic element 6, the coils are located along the respective ends of the metallic element 6. Portions of the metallic element 6 where a high density of eddy current appears can be utilized. Therefore, an antenna unit exhibiting superior communication performance can be provided.

The embodiment of the present invention is hereunder described by reference to the drawings.

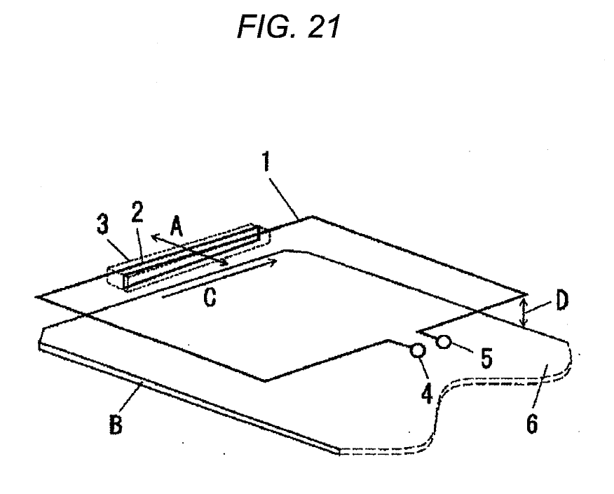

FIG. 21 is a conceptual rendering of the antenna unit of the present invention.

In the present embodiment, the loop antenna 1 is controlled so as to be able to transmit or receive; for instance, an RFID (13.56 MHz) radio wave.

In the present embodiment, the core 3 around which the coil 2 is wound is inserted into an arbitrary one point on the line making up the loop antenna 1.

The coil 2 is inserted into a point where the coil opposes the antenna input/output terminals 4 and 5.

It is thereby possible to freely form the loop antenna 1 by connecting the coil 2 to the antenna input/output terminals 4, 5 and during formation of the loop antenna.

Further, when the coil axis of the coil 2 is taken as A, the coil 2 has an arrangement in which the coil axis A is parallel to the aperture area of the loop antenna 1 and perpendicular to a direction of an electric current flowing through portions of the line of the loop antenna 1 before and after the point where the coil is inserted (i.e., a direction C in FIG. 21 in the embodiment).

Although the coil axis A is perpendicular to the direction C in the embodiment, the coil axis may be oriented in any direction, so long as the coil axis remains not parallel to the direction C.

In the embodiment, the coil 2 is arranged so as to become perpendicular to end faces B of the metallic element 6 while spaced apart from the same by a distance D. A conceivable distance D ranges from 0 mm to ∞. However, as will be described later, the antenna unit exhibits superior communication performance in either event.

The number of magnetic fluxes passing through the coil 2 can be increased, and communication performance exhibited when the metallic element 6 approaches the antenna unit can also be enhanced. Therefore, use of a magnetic substance for the core 3 is preferable. However, the core 3 is not limited to the magnetic substance but can also be formed from ceramic, a resin, or the like.

The coil 2 is arranged so as to be situated at an end of the metallic element 6, thereby enabling the maximum use of the electric current flowing through the metallic element 6.

The number of turns of the conductor of the coil 2 is illustrated as about 1.5 turns in the present embodiment. The number of conductor turns wound around the side of the core 3 facing the metallic element (i.e., the number of conductor turns wound around the side of the core 3 facing the metallic element when the conductor is wound around the core 3) becomes smaller than the number of conductor turns wound around another side of the core 3 opposite to its side facing the metallic element.

Such an arrangement makes it possible to realize an efficient antenna unit by means of a smaller number of turns.

In FIG. 21, a longitudinal direction of the rectangular parallelepiped core 3 is arranged on the loop antenna 1. However, a lateral direction of the core 3 can also be arranged. The shape of the coil 2 and the shape of the core 3 can freely be selected according to a desired characteristic and a space where the antenna is to be mounted.

However, when the lateral direction of the core is arranged, it goes without saying that the coil 2 is wound around the core 3 in its lateral direction, to thus make the coil.

FIG. 19 shows results of a winding number test. Winding numbers are plotted along a horizontal axis, and values acquired by normalization of magnetic field intensity induced by a 0.5 turn are plotted along a vertical axis. In the coil 2 used in the test, ferrite measuring 21 mm×4 mm×0.2 mm was used for the core 3. The coils were experimentally manufactured from a thin copper plate having a thickness of 0.1 mm while the width of the copper plate was changed from 1 mm to 0.6 mm in accordance with the number of turns. The coil 2 was placed in close proximity to the end of the metallic element; 50Ω matching was provided at 13.56 MHz; and a sinusoidal wave signal that exhibited a sensitivity of 20 dBm at 13.56 MHz was input from the signal generator to the antenna, and magnetic field intensity was measured at a point elevated 30 mm from the principal plane of the metallic element.

As shown in FIG. 19, the magnetic field intensity increases with an increase in winding number. However, an increase rate shows that the magnetic field intensity greatly increases when the winding number is larger than an integral number by one-half of turn. The conductor situated on a side where the conductor does not face the metallic element 6 is less susceptible to the eddy current flowing over the surface of the metallic element 6. However, an electric current develops, in a direction of being cancelled by the eddy current flowing over the surface of the metallic element 6, in the conductors of the coil 2 situated on a side where the conductors face the metallic element 6. Therefore, an increase in magnetic field intensity can be presumed to be small when the winding number assumes an integral number.

The test shown in FIG. 19 was conducted while the loop antenna 1 was not provided. However, even when the loop antenna 1 is formed, the coil 2 is considered to undergo similar influence from the metallic element 6. Therefore, an efficient antenna unit requiring a smaller number of turns can be said to be formed even from the coil 2 inserted into the loop antenna 1.

A limitation is not imposed on the number of turns. The number of turns may be larger or smaller than about 1.5 turns shown FIG. 21.

As a result of the number of turns being increased or decreased as compared with an integral multiple by about one-half of turn, both ends of the coil 2 (portions of the coil connected to the loop antenna 1) are formed on both sides with the core 3 sandwiched therebetween. Therefore, insertion of the coil into the loop antenna 1 becomes easier.

Specifically, since the coil can be inserted in such a way that a linear portion of an ordinary loop antenna is replaced with the coil, insertion of the coil becomes easier.

Further, a way to wind the coil 2 may be clockwise or counterclockwise. According to a position where the antenna is to be placed, the way to wind the coil can be selected, as required.

A commonly utilized connection method, such as a soldered connection and a connector connection, can be used for making a connection between the coil 2 and the conductor of the loop antenna 1. Alternatively, the coil 2 and the loop antenna 1 can also be formed from a single continuous conductor. As is commonly known, the antenna input/output terminals 4 and 5 are to be connected to input/output terminals of the matching circuit and the IC. A commonly utilized method, such as a pin contact, a spring contact, pin soldering, spring soldering, and a connector connection, can be utilized, as a connection method.

The antenna unit is built from the loop antenna 1, the coil 2, the cores 3, and antenna input/output terminals 4 and 5 that are provided in close proximity to the metallic element 6. The coil 2 is arranged so as to come to an end of the metallic element 6. When a magnetic field perpendicular to the aperture area of the loop antenna 1 comes from the outside, an eddy current develops in a surface of the metallic element 6. The eddy current exhibits a higher density closer to the end of the metallic element 6. Since the eddy current flowing over the surface of the metallic element 6 can most efficiently be utilized, it is preferable to place the coil 2 so as to be situated at the end of the metallic element 6. Further, since a density of the eddy current becomes lower at a corner of the metallic element 6, avoiding placement of the coil 2 at the corner is desirable.

FIG. 21 shows an arrangement in which the loop antenna 1 and the metallic element 6 are spaced apart from each other with a certain degree of spacing. When the loop antenna is placed in a portable terminal, or the like, spacing cannot be assured in some cases. In this case, the loop antenna 1 and the metallic element 6 are arranged in close proximity to each other.

The metallic element 6 becomes equivalent to; for instance, a substrate in the portable terminal. However, the metallic element can also be equivalent to another metallic element; for instance, a battery, a liquid crystal display panel, or the like.

Moreover, the conductor making up the loop antenna 1 can also be formed from a sheathed copper line, or the like. However, the conductor can also be an electrode pattern, or the like, laid on the metallic element 6. In addition, the coil 2 and the magnetic core 3 can also be arranged while mounted on the metallic element 6.

Although un-illustrated, the another component; for instance, a camera module, a speaker, an RF module, an antenna for another frequency, and others, can be mounted in interior spacing of the loop antenna 1.

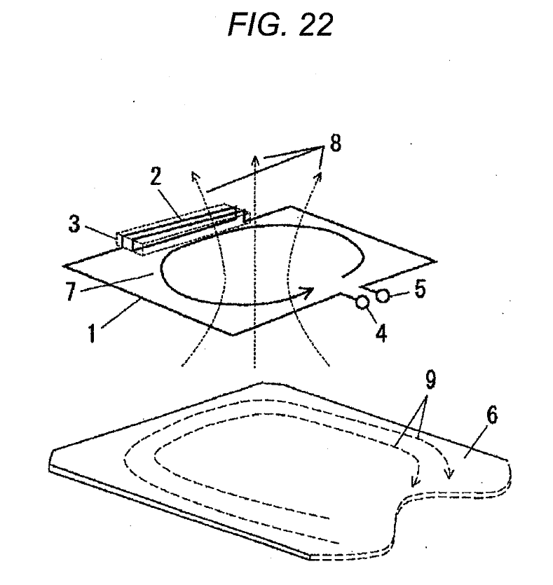

Operating concepts of the antenna unit of the present invention are now described by reference to FIGS. 22 through 25.

FIG. 22 is a conceptual rendering of the present invention achieved when the metallic element is located at the distant position and when an antenna performs transmission. By means of a signal input to the antenna input/output terminals 4 and 5, the electric current 7 flows into the loop antenna 1, whereupon the magnetic field 8 develops. The magnetic field 13 induced by the coil 2 is perpendicular to the magnetic field 8 and hence does not exert any influence on the magnetic field 8. Although an eddy current 9 develops in the metallic element 6 in a direction of canceling the magnetic field 8 induced by the electric current 7, the eddy current does not exert much influence on the magnetic field 8, because the metallic element 6 is situated at the distant position. Therefore, when the metallic element 6 is located at the distant position, the antenna unit effects communication in the same manner as does a related art loop antenna. For this reason, even when the metallic element is located at the distant position, a superior communication state can be acquired.

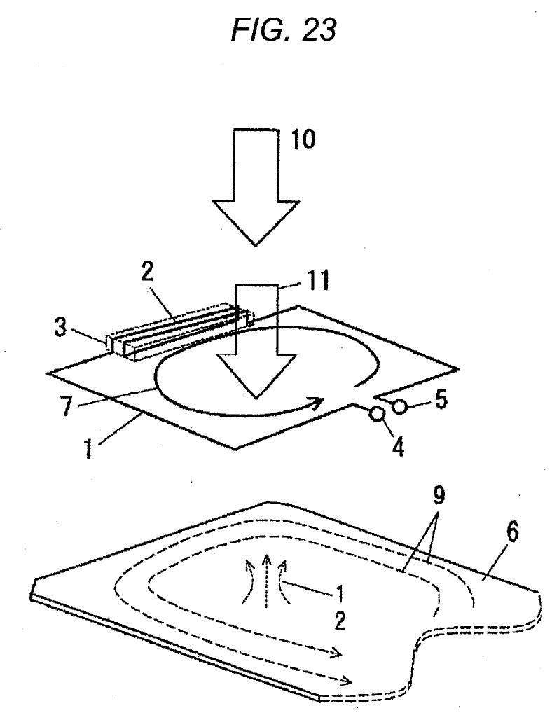

FIG. 23 is a conceptual rendering of the present invention achieved when the metallic element is located at the distant position and when the antenna receives a magnetic field from the outside. The external magnetic field 10 and the magnetic field 11 passing through the loop antenna 1 are related to a distance. The electric current 7 is induced in the loop antenna 1 by the magnetic field 11 and goes out of the antenna from the antenna input/output terminals 4 and 5. Since the coil axis of the coil 2 is perpendicular to the magnetic field 11, the coil axes do not exert influence on the electric current 7. Although the eddy current 9 is induced in the metallic element 6 by the magnetic field 10, to thus resultantly induce a magnetic field 12 in opposite direction, the magnetic field exerts little influence on the electric current, because the metallic element 6 is placed at the distant position. Therefore, when the metallic element 6 is placed at the distant position, the antenna unit effects communication in the same manner as does the related art loop antenna, the antenna unit of the present invention can provide a superior communication state even when the metallic element is located at the distant position.

Specifically, in the present embodiment, the coil 2 is arranged such that an electric current arises in a direction of canceling the eddy current 9.

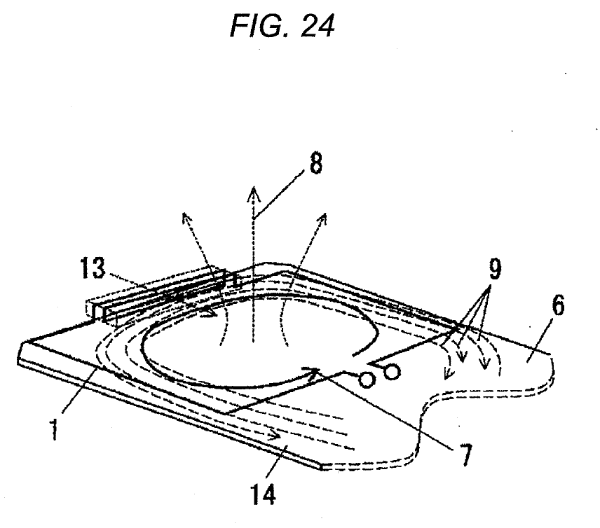

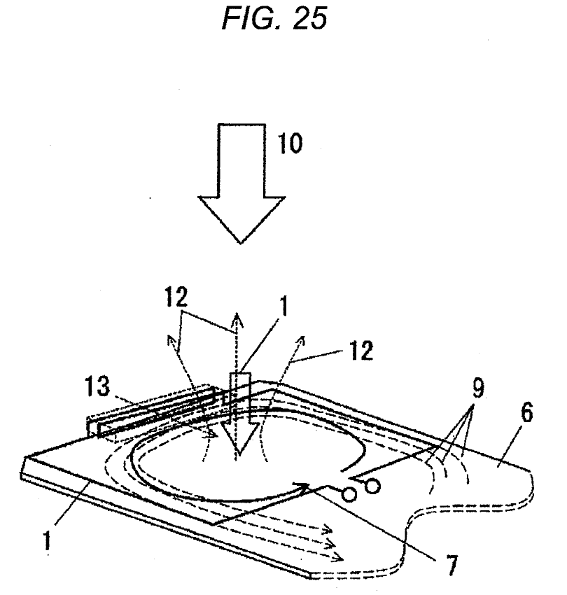

FIG. 24 is a conceptual rendering of the present invention achieved when the metallic element is located at the close position and when the antenna performs transmission. The signal entered the antenna input/output terminals 4 and 5 induces the electric current 7 in the loop antenna 1, whereupon the magnetic field 8 develops. The eddy current 9 develops in the metallic element 6 in a direction of canceling the magnetic field 8 induced by the electric current 7. The magnetic field 8 is supposed to consequently become smaller, thereby deteriorating the communication performance of the antenna. However, the magnetic field 13 passing through the coil 2 is induced by the electric current flowing through the coil 2, and an electric current 14 is induced in the metallic element 6 by the magnetic field 13. Since the electric current 14 is opposite in direction to the eddy current 9 and since they cancel each other, the magnetic field 8 eventually undergoes little influence from the eddy current 9. Therefore, even when the metallic element 6 is placed at the close position, the antenna unit of the present invention can provide a superior communication state.

FIG. 25 is a conceptual rendering of the present invention achieved when the metallic element is placed at the close position and when the antenna receives a magnetic field from the outside. The external magnetic field 10 induces the electric current 7 in the loop antenna 1, as well as inducing the eddy current 9 in the metallic element 6. Since the metallic element 6 and the loop antenna 1 are located adjacently, the magnetic field 11 passing through the loop antenna 1 is supposed to be reduced by the magnetic field 12 induced in the opposite direction by the eddy current 9, with the result that the electric current 7 will become smaller. However, the magnetic field induced by the eddy current 9 passes through the coils 2, whereby an electric current generating the magnetic field 13 flows into the coils 2. The electric current 7 consequently does not become smaller in quantity. Therefore, even when the metallic element 6 is placed at the close position, the antenna unit of the present invention can provide a superior communication state.

In the states in FIGS. 24 and 25 corresponding to the embodiment, the metallic element 6 can also be said to be utilized as an antenna by utilization of the electric current flowing through the metallic element 6. Since the metallic element of the portable terminal is larger than the antenna unit, the ability of a small-footprint antenna to utilize a large metallic element as an antenna unit is considered to be able to greatly contribute to a reduction in size and thickness of a portable terminal in future.

Although the loop antenna 1 is illustrated by one turn in the aforementioned drawings, the number of turns is not limited to one but may be plural. When a number of turns are employed, it is preferable to form only a portion of the outermost periphery path of the loop antenna 1 from the coils 2 or to insert cores into paths of respective turns such that the coil axis of the coils 2 become common, because deterioration of communication performance that will arise when the metallic element comes close to the antenna unit is lessened. Although the antenna is illustrated by means of one line, this is intended for the brevity of the drawings. In reality, the antenna has a width and thickness.

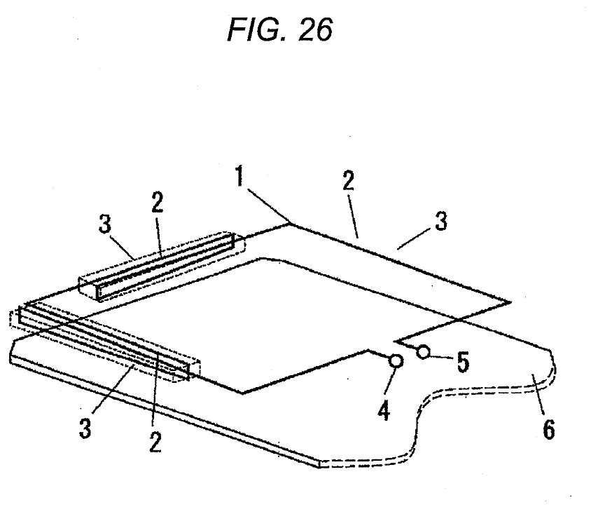

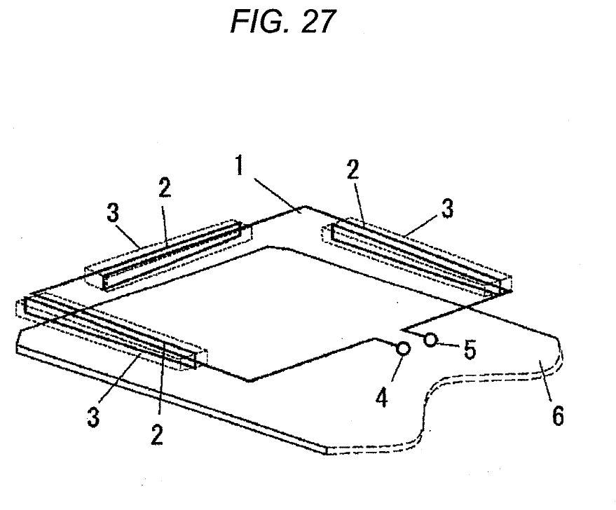

An arrangement of the antenna unit of the present invention is now described. In addition to the previously mentioned coil arrangement, the coil 2 can also be additionally provided in any one of two sides adjacent to the side where the coil 2 is already provided when the loop antenna 1 is formed into the shape of a rectangular parallelepiped as shown in FIG. 26. Alternatively, the coil 2 can also be provided in all of the sides except a side where the antenna input/output terminals 4 and 5 are provided as shown in FIG. 27. When a consideration is given to the degree of freedom achieved at the time of generation of the loop antenna 1, it is desirable to place the coil 2 at a position opposing the antenna input/output terminals 4 and 5.

The antenna unit of the present invention can maintain communication characteristics of the antenna without regard to a distance between the antenna and the metallic element provided on an enclosure on which the antenna is mounted. Consequently, the antenna unit is useful as an antenna for various electronic devices, such as portable phones.

The disclosure of Japanese Patent Application No. 2009-197843 filed Aug. 28, 2010, Japanese Patent Application No. 2010-060618 filed Mar. 17, 2010, and Japanese Patent Application No. 2010-103295 filed Apr. 28, 2010, including specification, drawings and claims is incorporated herein by reference in its entirety.

What is claimed is:

1. An antenna unit comprising:
a loop antenna; and
a coil inserted into a line of the loop antenna, wherein
a coil axis of the coil is parallel to an aperture area of the loop antenna and not parallel to a direction of an electric current flowing through portions of the line of the loop antenna before and after a point where the coil is inserted.

2. The antenna unit according to claim 1, wherein the coil is provided in numbers in the loop antenna.

3. The antenna unit according to claim 1, wherein turns of a conductor making up the coil are larger or smaller than an integral multiple by about one-half of turn.

4. The antenna unit according to claim 3, wherein a metallic element is provided on one side of the aperture area of the loop area, and the conductor wound around a side of the coil facing the metallic element is smaller in number than the conductor wound around a side of the coil opposite to its side facing the metallic element.

5. The antenna unit according to claim 2, wherein the coil is inserted into mutually-opposing two sides of the loop antenna.

6. The antenna unit according to claim 1, wherein, when the loop antenna is placed in close proximity to a metallic element, the coil is situated at an end of the metallic element.

7. The antenna unit according to claim 1, wherein the coil corresponds to at least two coils that are inserted in a line of the loop antenna and along mutually-opposing sides.

8. The antenna unit according to claim 7, wherein the two coils are equal in length to each other in their longitudinal directions.

9. The antenna unit according to claim 1, wherein an entirety of each of sides of the loop antenna is made up of a coil.

10. The antenna unit according to claim 7, wherein roll centers of the two coils are arranged so as to become offset from each other.

11. The antenna unit according to claim 1, wherein the coil corresponds to at least one coil that is placed in a line of the loop antenna and that is inserted into a position where the terminals oppose each other.

12. A communication device comprising:
an antenna unit including a loop antenna and a coil inserted into a line of the loop antenna; and
a metallic element by way of which the loop antenna is placed in close proximity to a substrate, wherein
a coil axis of the coil is parallel to an aperture area of the loop antenna and not parallel to a direction of an electric current flowing through portions of the line of the loop antenna before and after a point where the coil is inserted.

13. The communication device according to claim 12, wherein the coil is situated at an end of the metallic element.

14. A communication device comprising:
an antenna unit including a loop antenna and a coil inserted into a line of the loop antenna;
a substrate connected to the antenna unit; and
an enclosure enclosing the antenna unit and the substrate, wherein
a coil axis of the coil is parallel to an aperture area of the loop antenna and not parallel to a direction of an electric current flowing through portions of the line of the loop antenna before and after a point where the coil is inserted.

15. The antenna unit according to claim 14, wherein the substrate is a metallic element;
the loop antenna is placed in close proximity to the substrate; and
the coil is situated at an end of the substrate.

16. The antenna unit according to claim 14, wherein the enclosure is a metallic element;
the loop antenna is placed in close proximity to the enclosure; and
the coil is situated at an end of the enclosure.
